(19) United States
(12) Patent Application Publication
(10) Pub. No.: US 2019/0200032 A1
(43) Pub. Date: Jun. 27, 2019

(54) IMAGING APPARATUS, IMAGING METHOD AND STORAGE MEDIUM

(71) Applicant: CASIO COMPUTER CO., LTD., Tokyo (JP)

(72) Inventor: Kenji Iwamoto, Tokyo (JP)

(21) Appl. No.: 16/228,127

(22) Filed: Dec. 20, 2018

(30) Foreign Application Priority Data
Dec. 25, 2017 (JP) 2017-248339

(51) Int. Cl. H04N 19/513; H04N 5/225; H04N 5/232; G06T 7/207; G03B 13/36

(52) U.S. Cl. CPC H04N 19/513; H04N 5/2254; H04N 5/23254; H04N 5/23296; H04N 5/23267; G03B 13/36; H04N 5/22525; G06T 7/207

(57) ABSTRACT

An object is to enable a suitable image conforming to the movement of an imaging target to be captured. A motion detection device provided on an imaging target side (person or movement object) detects the motion of the imaging target, which is transmitted as motion information. An imaging apparatus receives the motion information detected by the motion detection device, predicts the motion of the imaging target based on the motion information, changes imaging settings based on the predicted motion of the imaging target and controls imaging function based on the imaging settings.

### CROSS-REFERENCE TO RELATED APPLICATION

This application is based upon and claims the benefit of priority from the prior Japanese Patent Application No. 2017-248339, filed Dec. 25, 2017, the entire contents of which are incorporated herein by reference.

### BACKGROUND OF THE INVENTION

### 1. Field of the Invention

The present invention relates to an imaging apparatus that controls image capturing based on imaging settings, an imaging method and a storage medium.

### 2. Description of the Related Art

In image capturing of an imaging target (main photographic subject) by an imaging apparatus such as a digital camera, when camera shake occurs by the camera being unstably held or motion blurring occurs due to the movement of the photographic subject, image blurring occurs in the captured image. Conventionally, as a technique for detecting such image blurring, a technique has been disclosed in Japanese Patent Application Laid-Open (Kokai) Publication No. 2008-166974 in which the image of the N-th frame and the image of the N-th+1 frame are compared with each other, the difference between them is acquired as a moving vector, and a judgment that motion blurring has occurred is made when image blurring is detected in a portion of the images.

### SUMMARY OF THE INVENTION

In accordance with one aspect of the present invention, there is provided an imaging apparatus comprising: an imaging section; an acquisition section which acquires motion information regarding a motion of an imaging target detected by a motion detection device located on the imaging target side, from the motion detection device; a prediction section which predicts a motion of the imaging target based on the motion information acquired by the acquisition section; a setting section which executes imaging settings based on the motion of the imaging target predicted by the prediction section; and a control section which controls the imaging section based on contents of the imaging settings executed by the setting section.

In accordance with another aspect of the present invention, there is provided an imaging apparatus comprising: an imaging section; an acquisition section which acquires motion information regarding a motion of an imaging target detected by a motion detection device located on the imaging target side, from the motion detection device; a judgment section which judges a type of a movement object that is the imaging target by analyzing the motion information acquired by the acquisition section; a setting section which executes imaging settings based on the type of the movement object judged by the judgment section; and a control section which controls the imaging section based on contents of the imaging settings executed by the setting section.

In accordance with another aspect of the present invention, there is provided an imaging apparatus comprising: an imaging section; an acquisition section which acquires information which is regarding a type of a movement object serving as an imaging target and has been detected by a motion detection device located on the movement object side, from the motion detection device; a setting section which executes imaging settings based on the information regarding the type of the movement object acquired by the acquisition section; and a control section which controls the imaging section based on contents of the imaging settings executed by the setting section.

In accordance with another aspect of the present invention, there is provided an imaging method for an imaging apparatus, comprising: a step of acquiring motion information regarding a motion of an imaging target detected by a motion detection device located on the imaging target side, from the motion detection device; a step of predicting a motion of the imaging target based on the acquired motion information; a step of executing imaging settings based on the predicted motion of the imaging target; and a step of controlling an imaging section based on contents of the executed imaging settings.

In accordance with another aspect of the present invention, there is provided a non-transitory computer-readable storage medium having a program stored thereon that is executable by a computer in an imaging apparatus to actualize functions comprising: processing for acquiring motion information regarding a motion of an imaging target detected by a motion detection device located on the imaging target side, from the motion detection device; processing for predicting a motion of the imaging target based on the acquired motion information; processing for executing imaging settings based on the predicted motion of the imaging target; and processing for controlling an imaging section based on contents of the executed imaging settings.

In accordance with another aspect of the present invention, there is provided an imaging method for an imaging apparatus, comprising: a step of acquiring motion information regarding a motion of an imaging target detected by a motion detection device located on the imaging target side, from the motion detection device; a step of judging a type of a movement object that is the imaging target by analyzing the acquired motion information; a step of executing imaging settings based on the judged type of the movement object; and a step of controlling an imaging section based on contents of the executed imaging settings.

In accordance with another aspect of the present invention, there is provided a non-transitory computer-readable storage medium having a program stored thereon that is executable by a computer in an imaging apparatus to actualize functions comprising: processing for acquiring motion information regarding a motion of an imaging target detected by a motion detection device located on the imaging target side, from the motion detection device; processing for judging a type of a movement object that is the imaging target by analyzing the acquired motion information; processing for executing imaging settings based on the judged type of the movement object; and processing for controlling an imaging section based on contents of the executed imaging settings.

In accordance with another aspect of the present invention, there is provided an imaging method for an imaging apparatus, comprising: a step of acquiring information which is regarding a type of a movement object serving as an imaging target and has been detected by a motion detection device located on the movement object side, from the motion detection device; a step of executing imaging settings based on the acquired information regarding the type of the movement object; and a step of controlling an imaging section based on contents of the executed imaging settings.

In accordance with another aspect of the present invention, there is provided an imaging method for an imaging apparatus, comprising: a step of acquiring pieces of motion information regarding motions of a plurality of imaging targets detected by a plurality of motion detection devices respectively located on each imaging target side, from the plurality of motion detection devices; a step of comparing the acquired pieces of motion information of the plurality of imaging targets, and executing imaging settings based on a piece of motion information selected in accordance with a comparison result; and a step of controlling an imaging section based on the executed imaging settings.

According to the present invention, suitable images conforming to the motion of an imaging target can be captured.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a diagram exemplarily showing image capturing of an imaging target by an imaging apparatus 2 in an imaging system where a motion detection device 1 for detecting the motion of the imaging target and the imaging apparatus 2 having an imaging function have been connected by communication connection;

FIG. 2 is a block diagram showing basic components of the motion detection device 1;

FIG. 3 is a block diagram showing basic component of the imaging apparatus 2;

FIG. 4A is a diagram for describing a state where “imaging settings” are changed to achieve “image quality priority” based on the motion of an imaging target;

FIG. 4B is a diagram for describing a state where “imaging settings” are changed to achieve “image blurring measure priority” based on the motion of an imaging target;

FIG. 5 is a flowchart outlining the operation of the motion detection device 1 which is started upon power-on;

FIG. 6 is a flowchart outlining the operation of the imaging apparatus 2 which is started when a current mode is switched to an imaging mode;

FIG. 7A to FIG. 7C are diagrams for conceptually describing a feature of a second embodiment;

FIG. 8 is a flowchart outlining the operation of the imaging apparatus 2 when a current mode is switched to an imaging mode in the second embodiment;

FIG. 9 is a diagram for describing a first modification example of the second embodiment;

FIG. 10 is a diagram for describing a setting table 23d that is used in a third embodiment;

FIG. 11 is a flowchart showing a characteristic operation of the imaging apparatus 2 in an imaging mode in a third embodiment;

FIG. 12 is a flowchart showing a characteristic operation of the imaging apparatus 2 in an imaging mode in a fourth embodiment; and

FIG. 13 is a diagram for describing image capturing of a plurality of imaging targets by the imaging apparatus 2 in a fifth embodiment; and

FIG. 14 is a flowchart showing a characteristic operation of the imaging apparatus 2 in the fifth embodiment.

### DETAILED DESCRIPTION OF THE PREFERRED EMBODIMENTS

Embodiments of the present invention will hereinafter be described in detail with reference to the drawings.

### First Embodiment

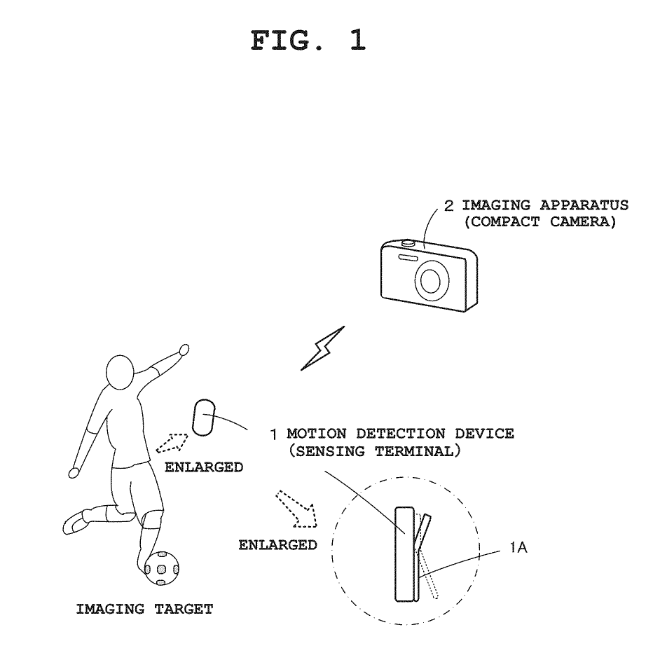

First, a first embodiment of the present invention is described with reference to FIG. 1 to FIG. 6.

In the present embodiment, the present invention has been applied in a compact camera as an imaging apparatus. FIG. 1 is a diagram exemplarily showing image capturing of an imaging target (main photographic subject) by this camera. More specifically, FIG. 1 is a diagram showing an example in which, in an imaging system where a motion detection device 1 provided on the imaging target side so as to detect the motion of the imaging target and an imaging apparatus 2 having an imaging function have been connected by communication connection, the imaging apparatus 2 photographs the imaging target in accordance with the motion of the imaging target detected by the motion detection device 1.

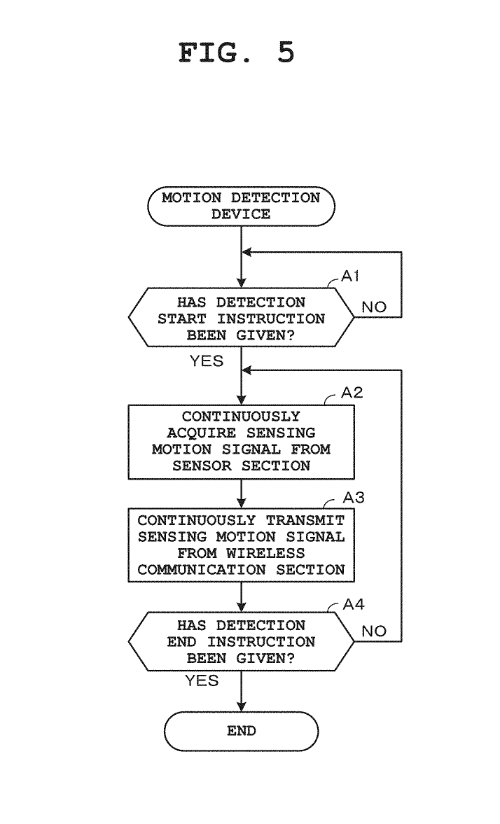

The motion detection device 1 is a device that is detachably worn on an imaging target (main photographic subject). In the shown example, an athlete who is about to kick a soccer ball is an imaging target, and the motion detection device 1 has been worn on the waist of the athlete. Note that the “enlargement” in the drawing represents the enlargement of the motion detection device 1. This motion detection device 1 is a compact wearable motion sensor (sensing terminal) having various sensors (not shown in FIG. 5), and includes an attachment section 1A that can be detachably worn on an arbitrary part of the imaging target. Note that the circular portion described with a dashed line is an enlarged drawing for showing one side surface thereof. The attachment section 1A has a simple structure and can be attached only by being clipped to the waist belt of the user, as shown in the drawing. However, the structure of the attachment section 1A is not limited this structure using a clip, and any structure may be adopted as long as it can be detachably fixed on an imaging target.

Although the motion detection device (sensing terminal) 1 is directly worn on the imaging objet (main photographic subject) in the example of the present embodiment, the motion detection device 1 is not required to be worn on the imaging target if the motion of the imaging target can be detected. That is, the motion detection device 1 is only required to be on the imaging target side, and therefore may be indirectly attached to the imaging target. The motion detection device 1 and the imaging apparatus 2 are communicable (data transmission or reception can be performed) with each other by wireless communication, and a sensing motion signal of the motion of an imaging target detected by the motion detection device 1 is continuously transmitted to the imaging apparatus (compact camera) 2 as motion information indicating the motion of the imaging target.

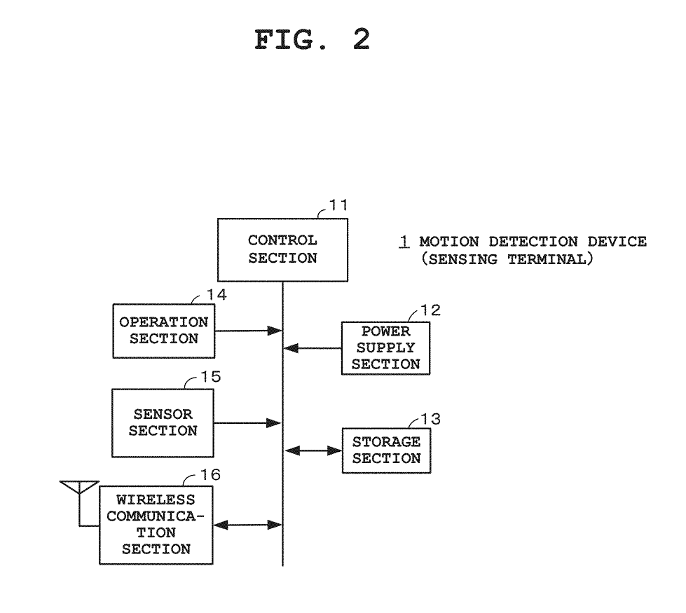

FIG. 2 is a block diagram showing basic components of the motion detection device 1.

The motion detection device 1 has a control section 11 as its centerpiece. The control section 11 operates by power supply from a power supply section (secondary battery) 12 and controls the entire operation of the motion detection device 1 in accordance with various programs stored in a storage section 13. This control section 11 includes a CPU (Central Processing Unit) and a memory (not shown). The storage section 13, which includes a ROM (Read-Only Memory) and a flush memory, has stored therein a program and various applications for causing the CPU to perform processing according to an operation procedure shown in FIG. 5 so as to actualize the first embodiment.

To the control section 11, an operation section 14, a sensor section 15, and a wireless communication section 16 are connected as its input and output devices. Although not shown, the operation section 14 has a power supply switch for turning on and off the power. The sensor section 15 has various sensors such as a triaxial acceleration sensor, a gyro sensor, and a geomagnetic sensor (not shown), and detects acceleration, inclination, direction and the like. This sensor section 15 constitutes a three-dimensional motion sensor which detects various motions such as slow motions and quick motions by taking advantage of the characteristics of the sensors. Note that, although the motion detection device 1 has a thin and rectangular housing and detects a motion with the direction of the short side of the housing as an X-axis direction, the direction of the long side of the housing as a Y direction, and the thickness direction of the housing as a Z direction in a triaxial system, the various sensors constituting the sensor section 15 are not limited to triaxial sensors.

When the motion of an imaging target is detected by the sensor section 15, a sensing motion signal that successively fluctuates in accordance with the motion of the imaging target is transmitted to the wireless communication section 16 as motion information showing the motion of the imaging target.

The wireless communication section 16 actualizes a short-distance wireless communication function of Bluetooth (registered trademark) standards or a wireless LAN (Local Area Network) function and transmits, in real time, a sensing motion signal related to the motion of an imaging target (motion information regarding the motion of an imaging target) detected by the sensor section 15.

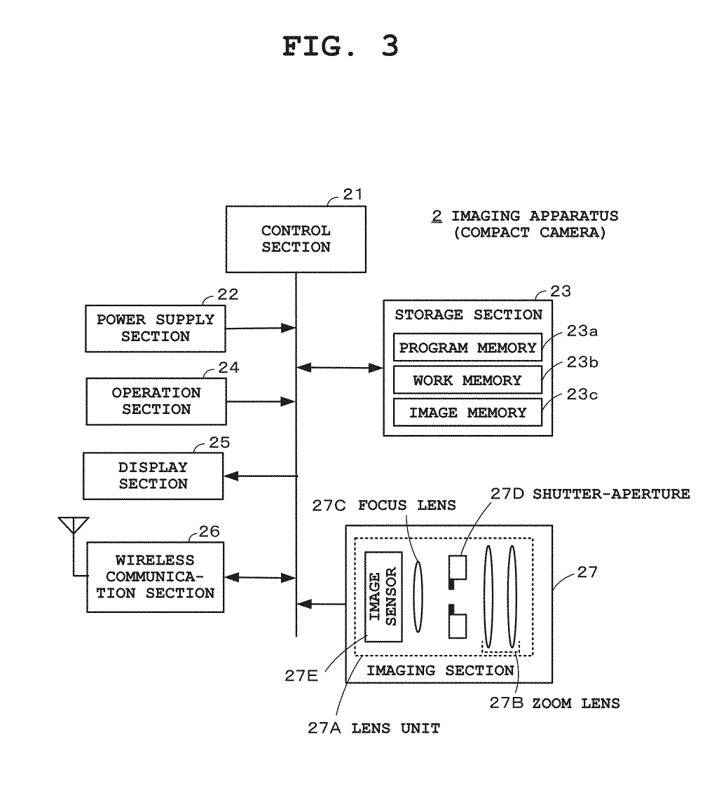

FIG. 3 is a block diagram showing basic components of the imaging apparatus 2.

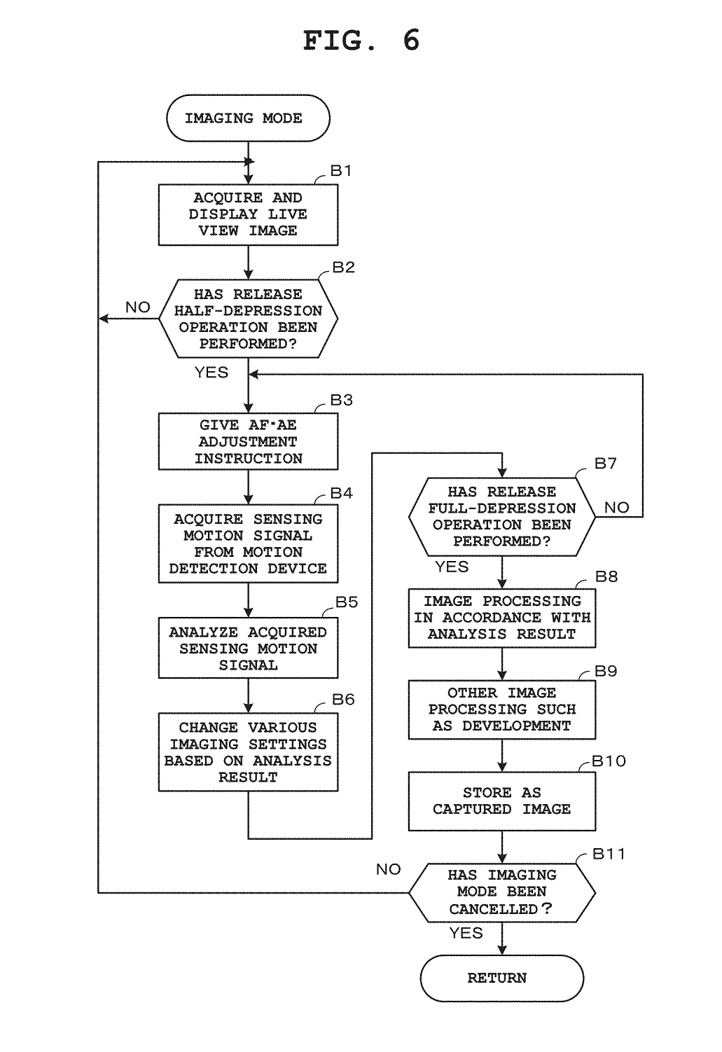

A control section 21 in FIG. 3 operates by power supply from a power supply section (secondary battery) 22 and controls the entire operation of the imaging apparatus 2 in accordance with various programs stored in a storage section 23. This control section 21 is provided with a CPU (not shown) and a memory. The storage section 23 includes, for example, a ROM and a flush memory, and has a program memory 23a having stored therein a program and various applications for causing the CPU to perform processing according to an operation procedure shown in FIG. 6 so as to actualize the first embodiment, a work memory 23b for temporarily storing data such as a flag, and an image memory 23c for storing captured images.

This storage section 23 may be structured to include a removable portable memory (recording medium) such as an SD (Secure Digital) card or a USB (Universal Serial Bus) memory, or may be structured to include a storage area on a predetermined server apparatus side in a case where the camera is connected to a network by a communication function. The imaging apparatus 2 is capable of performing various processing by various application programs being installed into the storage section 23. Although not shown, an operation section 24 in FIG. 3 includes a power supply key for turning on and off the power, a mode key for switching between an imaging mode and a playback mode, a release key of a two-stage depression (half-depression and full-depression) type, a zoom lever, a setting key for setting imaging parameters such as exposure and shutter speed. The control section 11 performs possessing in accordance with an input operation signal from this operation part 24.

A display section 25 in FIG. 3 is constituted by a high definition liquid crystal display, and the screen of this high definition liquid crystal display functions as a monitor screen (live view screen) for displaying images being captured (live view image) in real time and a playback screen for replaying a captured image. A wireless communication section 26 in FIG. 3 actualizes a short-distance wireless communication function of Bluetooth (registered trademark) standards ora wireless LAN function and receives, in real time, a sensing motion signal transmitted by the motion detection device 1. An imaging section 27 in FIG. 3 constitutes a camera capable of capturing a photographic subject with high definition. A lens unit 27A thereof is mainly constituted by an optical and mechanical system having a lens unit 27A, a zoom lens 27B, a focus lens 27C, a shutter-aperture 27D, and an image sensor 27E, and performs automatic focus adjustment (AF), automatic exposure adjustment (AE), and image capturing in accordance with an instruction from the control section 21.

When a photographic subject image is imaged in the image sensor 27E by the optical system, the image signal converted into an electrical signal (signal having an analogue value) is subjected to digital conversion, and displayed on the monitor of a display section 25 as a live view image. In the present embodiment, when an imaging instruction is given by a release operation, the control section 21 performs image processing such as camera-shake correction, white balance processing, sharpening processing, and facial treatment on the captured image as necessary. However, this image processing may be performed by the imaging section 27. Image data subjected to such image processing is compressed to have a predetermined size, and then recorded and stored in the image memory 23c (such as a SD card) of the storage section 23 as a captured image.

When a sensing motion signal is received from the motion detection device 1 via the wireless communication section 26, the control section 21 of the imaging apparatus 2 executes imaging settings based on the sensing motion signal. The “imaging settings” herein are not limited to settings of imaging parameters such as an aperture value, a shutter speed, and an ISO sensitivity which are set in response to a half-depression operation on the release key, and include settings by which camera-shake correction, white balance processing, and face treatment are performed as necessary. In the present embodiment, the control section 21 controls the imaging means (imaging function) based on the contents of the “imaging settings”. Note that the “imaging means” herein includes not only the imaging section 27, but also the control section 21. The “imaging function” herein refers to a series of functions that are performed from when image capturing is started until when a captured image is stored.

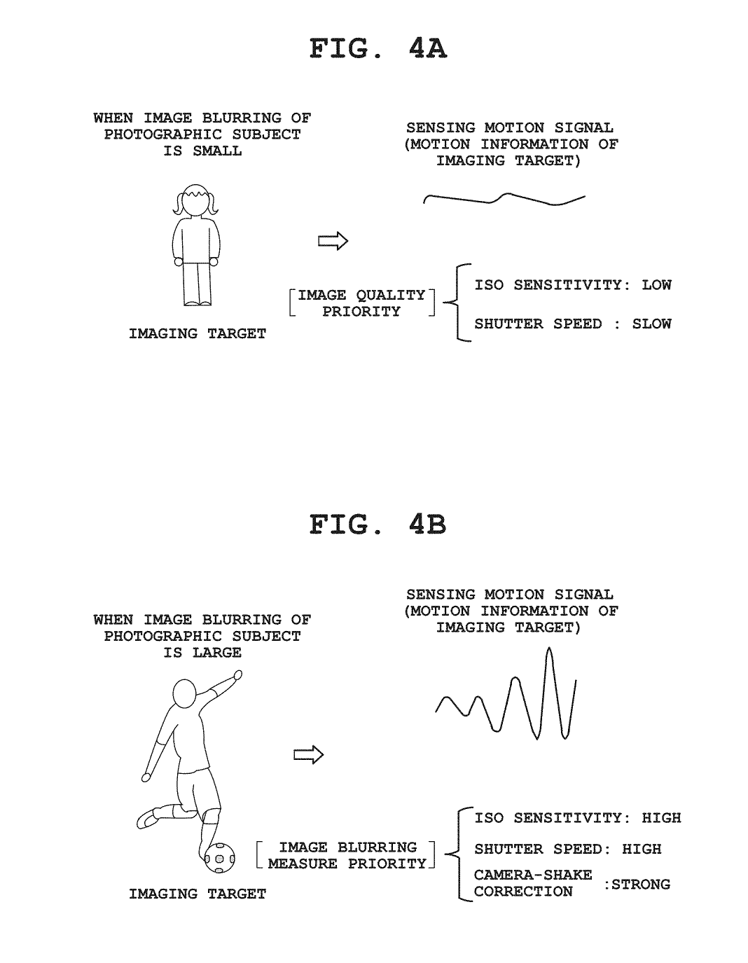

FIG. 4A is a diagram for describing a state where the “imaging settings” are changed to achieve “image quality priority” based on the motion of an imaging target.

FIG. 4A shows an example where a person standing still or slowly moving is photographed as an imaging target (photographic subject). The sensing motion signal in the drawing is to conceptually show motion changes of the imaging target in this case. In practice, this sensing motion signal has a more complicated motion signal waveform. When the fluctuation status (the number of times of fluctuation and the intensity of fluctuation) of the sensing motion signal is analyzed and a judgment is made that the motion blurring of the photographic subject is small, the control section 21 changes the “imaging settings” to achieve the “image quality priority” as shown in the drawing. In this case, for example, the control section 21 executes settings by which the ISO sensitivity is reduced, the shutter speed is decreased, and face treatment is performed.

FIG. 4B is a diagram for describing a state where the “imaging settings” are changed to achieve “image blurring measure priority” based on the motion of an imaging target.

FIG. 4B shows an example where an athlete who is about to kick a soccer ball is photographed as an imaging target. The sensing motion signal in the drawing is to conceptually show motion changes of the imaging target in this case, and has a more complicated motion signal waveform in practice. When the fluctuation status (the number of times of fluctuation and the intensity of fluctuation) of the sensing motion signal is analyzed and a judgment is made that the motion blurring of the photographic subject is large, the control section 21 changes the “imaging settings” to achieve the “image blurring measure priority” as shown in the drawing. In this case, for example, the control section 21 executes settings by which the ISO sensitivity is increased, the shutter speed is increased, and a greater camera-shake correction is performed. Note that the threshold value of the judgment as to whether the image blurring of the photographic subject is large or small may be arbitrarily determined by the user in advance. Also, the values of the “imaging settings” at the time of the “image quality priority” or the “image blurring measure priority” may be arbitrarily selected by the user in advance.

As such, the imaging apparatus 2 in the first embodiment determines a corresponding imaging mode based on a sensing motion signal acquired from the motion detection device 1, and executes imaging settings based on the determined imaging mode. Note that, although the imaging mode herein is a mode of giving priority to image quality (image quality priority) or a mode of giving priority to a measure against image blurring (image blurring measure priority), the present invention is not limited thereto and it may be, for example, an “aperture value priority mode” or a “shutter speed priority mode”. Each imaging mode is associated in advance with imaging settings having corresponding contents. In the imaging apparatus 2, when an imaging mode is determined based on a sensing motion signal, settings for image capturing is executed based on the “imaging settings” corresponding to this imaging mode.

Next, the operation concepts of the motion detection device 1 and the imaging apparatus 2 in the first embodiment are described with reference to the flowcharts shown in FIG. 5 and FIG. 6. Here, each function described in these flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later.

FIG. 5 is a flowchart outlining the operation of the motion detection device 1, which is started upon power up.

This flowchart is described based on an assumption that the motion detection device 1 has been worn on an arbitrary part of an imaging target (such as the person's waist) via the attachment section 1A. When the power of the motion detection device 1 is turned on, the control section 11 judges whether an instruction to start detection has been given, that is, judges whether a detection switch (not shown) of the operation part has been operated (Step A1). When judged that an instruction to start detection has been given (YES at Step A1), the control section 11 activates the sensor section 15, and continuously acquires a sensing motion signal (motion information regarding the motion of the imaging target) by this sensor section 15 (Step A2).

Subsequently, the control section 11 transmits the acquired sensing motion signal to the wireless communication section 16 such that the signal is continuously transmitted (Step A3). Then, the control section 11 judges whether an instruction to end the detection has been given, that is, judges whether the detection switch of the operation section 14 has been operated again (Step A4), and returns to Step A2 so as to repeat the above-described operations (Step A2 to Step A4) until a detection end instruction is given. Note that the instruction for starting or ending the detection herein may be given by not only an operation on the detection switch, but also by the reception of a signal instructing to start or end the detection from the imaging apparatus 2.

FIG. 6 is a flowchart outlining the operation of the imaging apparatus 2, which is started when a current mode is switched to an imaging mode.

When a current mode is switched to an imaging mode, the control section 21 of the imaging apparatus 2 enters a state of waiting for a release half-depression operation (Step B2) while displaying (Step B1) images acquired from the imaging section 27 on the monitor of the display section 25 as a live view image. Then, when a release half-depression operation is performed (YES at Step B2), the control section 21 instructs the imaging section 27 to perform automatic focus adjustment (AF) and automatic exposure adjustment (AE) (Step B3), acquires a sensing motion signal transmitted from the motion detection device 1 (Step B4), analyzes the sensing motion signal (Step B5), and performs processing for changing various “imaging settings” based on this analysis result (Step B6).

That is, when the control section 21 analyzes the sensing motion signal, and judges that the motion blurring of the photographic subject is small based on the fluctuation status (the number of times of fluctuation and the intensity of fluctuation) of the signal, the “imaging settings” are changed to achieve the “image quality priority” as shown in FIG. 4A. Conversely, when a judgment is made that the motion blurring of the photographic subject is large, the “imaging settings” are changed to achieve the “image blurring measure priority” as shown in FIG. 4B. Then, the control section 21 enters a state of waiting for a release full-depression operation (Step B7), and returns to Step B3 so as to repeat the above-described operations (Steps B3 to B7) until a release full-depression operation is performed.

When a release full-depression operation is performed (YES at Step B7), the control section 21 acquires an image captured based on the “imaging settings” (shutter speed) and performs, on this image, image processing (such as face treatment processing and camera-shake correction processing) indicated by the “imaging settings” acquired by the change at Step B6 (Step B8). Note that the face treatment herein is image processing in which, for example, a person in the image is detected, the exposure of the image is corrected with a skin color portion of the face, the neck, and the arms as a target, and the skin color is whitened by processing of correcting color saturation and brightness. The camera-shake correction processing herein is not optical camera-shake correction by shutter speed and ISO sensitivity, but is image processing of performing digital camera-shake correction, in which the movement amount and feature of a photographic subject is identified in image data and an image artificially having no camera-shake is acquired.

Next, the control section 21 performs image processing such as development and image compression on the captured image, generates data in a standard file format (Step B9), and stores it in the image memory 23c of the storage section 23 (Step B10).

Subsequently, the control section 21 judges whether the imaging mode has been cancelled (Step B11) and, when the current mode is still the imaging mode (NO at Step B11), returns to Step B1 to repeat the above-described operations. When the imaging mode is cancelled (YES at Step B11), the control section 21 exits the flow of FIG. 6 and returns to the main flow (not shown) of the entire operation of the imaging apparatus 2.

As described above, in the first embodiment, the imaging apparatus 2 acquires motion information regarding the motion of an imaging target detected by the motion detection device 1 from the motion detection device 1, changes the “imaging settings”, and controls the imaging means (imaging function) based on the changed “imaging settings”. As a result of this configuration, suitable images conforming to the motion of an imaging target can be captured. Accordingly, image capturing can be performed in which the effect of the image blurring of a photographic subject is suppressed.

Also, the imaging apparatus 2 determines a corresponding imaging mode based on motion information acquired from the motion detection device 1, and performs imaging settings based on the determined imaging mode. As a result of this configuration, an imaging mode is determined based on the motion of an imaging target, and suitable settings conforming to the motion of the imaging target are set.

Moreover, based on motion information acquired from the motion detection device 1, the imaging apparatus 2 controls whether the “imaging settings” are changed to settings where priority is given to image quality or are changed to settings where priority is given to a measure against image blurring.

As a result of this configuration, suitable settings conforming to the motion of an imaging target can be acquired.

Furthermore, the imaging apparatus 2 executes imaging settings whose contents have been associated with each imaging mode. As a result of this configuration, suitable settings can be executed for each imaging mode.

Still further, the “imaging settings” can include not only the settings of imaging parameters such as an aperture value, a shutter speed, and ISO sensitivity, but also the setting of contents for performing camera-shake correction processing, white balance processing, and face treatment. As a result of this configuration, various settings can be achieved.

Yet still further, in the first embodiment, in the imaging system where the motion detection device 1 having the detection means for detecting the motion of an imaging target and the imaging apparatus 2 having the imaging means have been communicably connected, motion information regarding the motion of the imaging target detected by the detection means of the motion detection device 1 is acquired, imaging settings are executed based on the acquired motion information, and the imaging means is controlled based on the contents of the settings. As a result of this configuration, suitable images conforming to the motion of an imaging target can be captured.

In the configuration of the imaging system of the first embodiment, the imaging apparatus 2 acquires motion information from the motion detection device 1, and executes imaging settings based on this motion information. However, the present invention is not limited thereto and a configuration may be adopted in which the motion detection device 1 analyzes motion information and transmits a notification to execute “imaging settings” having contents based on the analysis result to the imaging apparatus 2, and the imaging apparatus 2 controls the imaging means.

Also, in the first embodiment, based on motion information regarding the motion of an imaging target, the “imaging settings” are set to have contents by which “image quality priority” or “image blurring measure priority” is set. However, the present invention is not limited thereto and the “imaging settings” may be set to have contents by which “aperture value priority” or “shutter speed priority” is set. As a result, images showing the user's intended expression can be captured.

### Second Embodiment

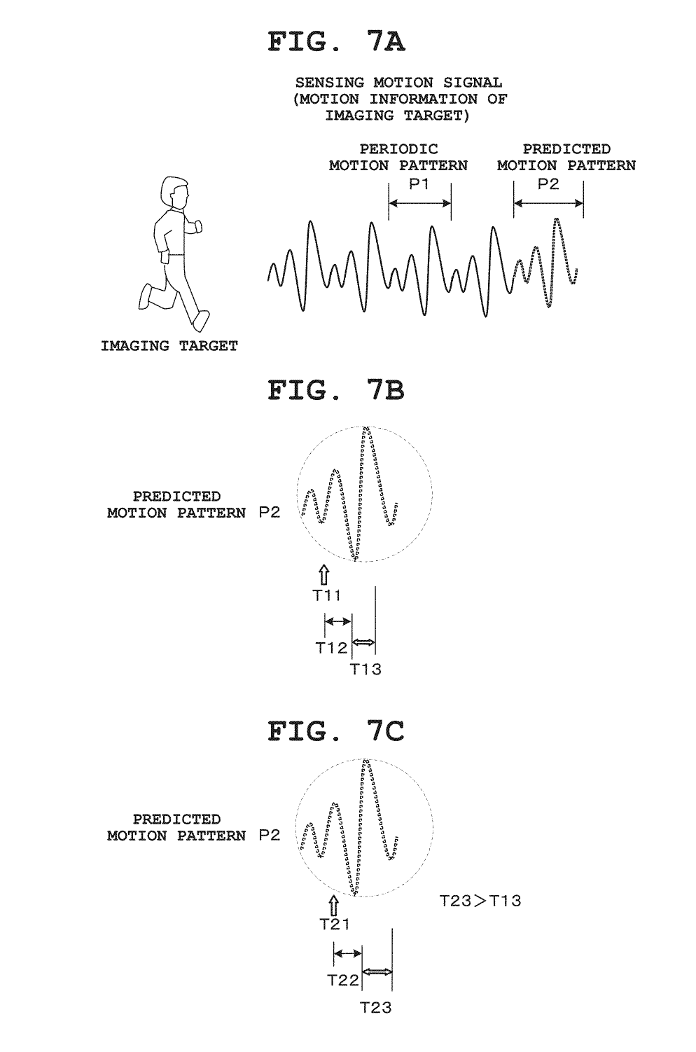

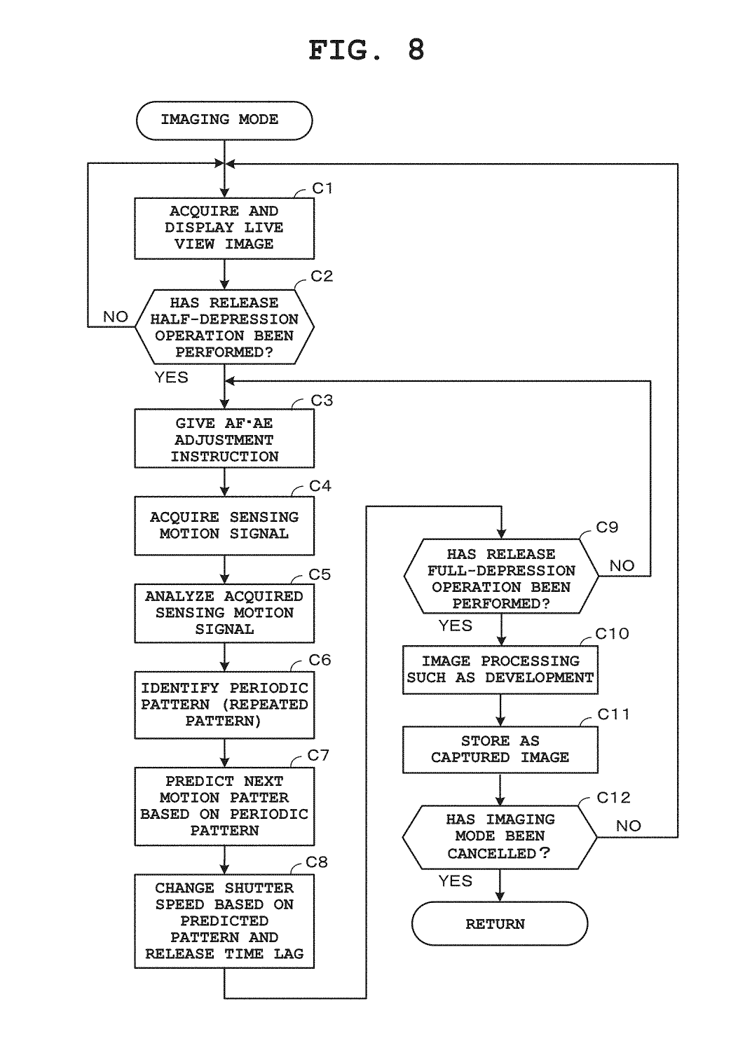

Next, a second embodiment of the present invention is described with reference to FIG. 7A to FIG. 7C and FIG. 8.

In the configuration of the first embodiment, the imaging apparatus 2 analyzes a sensing motion signal and changes the “imaging settings” based on the fluctuation status (the level of the image blurring of a photographic subject) of the signal.

However, in the configuration of the second embodiment, the imaging apparatus 2 identifies a motion pattern that repeatedly appears by analyzing a sensing motion signal, predicts the next motion of the imaging target based on this repeated pattern, and changes the “imaging settings” based on the pattern of the predicted motion. Here, sections that are basically the same as those of the first embodiment or sections having the same name in both embodiments are given the same reference numerals and descriptions thereof are omitted.

Hereafter, the characteristic portions of the second embodiment are mainly described.

FIG. 7A to FIG. 7C are diagrams for conceptually describing a feature of a second embodiment.

FIG. 7A is a drawing conceptually showing a sensing motion signal (waveform signal) that is successively fluctuating in accordance with the motion of an imaging target who is wearing the motion detection device 1 and jogging. The imaging apparatus 2 analyzes the sensing motion signal acquired from the motion detection device 1 so as to identify a repeatedly appearing motion pattern (periodic motion pattern) P1, and predicts the next motion pattern (predicted motion pattern) P2 of the imaging target based on the periodic motion pattern (repeated pattern) P1.

FIG. 7B and FIG. 7C are drawings showing a case where the “imaging settings” (setting of exposure time) are changed based on the motion pattern (predicted motion pattern) P2 predicted as described above and a delay time due to a release time lag. In FIG. 7B, “T11” indicates timing at which the release key is operated, “T12” indicates the delay time due to the release time lag, and “T13” indicates the actual exposure time after the release time lag. Similarly, in FIG. 7C, “T21” indicates timing at which the release key is operated, “T22” indicates a delay time due to a release time lag, and “T23” indicates the actual exposure time after the release time lag.

Whether the image blurring of the photographic subject is small or large can be judged based on the fluctuation status of the prediction pattern P. Therefore, in the present embodiment, even if the image blurring of the photographic subject is small at the operation timing T11 of the release key as shown in FIG. 7B, the shutter speed of the “imaging settings” is set to be faster (exposure time T13 is set to be shorter) than a standard value when it is predicted that the image blurring of the photographic subject becomes large after the delay time T12 due to the release time lag, based on the fluctuation status of the prediction patter P2. Also, even if the image blurring of the photographic subject is large at the operation timing T21 of the release key as shown in FIG. 7C, the shutter speed of the “imaging settings” is set to be slower (exposure time T13 is set to be longer) than the standard value when it is predicted that the image blurring of the photographic subject becomes small after the delay time T22 due to the release time lag, based on the fluctuation status of the prediction patter P2. Accordingly, a relationship of T23>T23 is established.

FIG. 8 is a flowchart outlining the operation of the imaging apparatus 2 which is started when a current mode is switched to an imaging mode in the second embodiment.

First, the control section 21 of the imaging apparatus 2 enters a state of waiting for a release half-depression operation (Step C2) while displaying (Step C1) images acquired from the imaging section 27 on the monitor of the display section 25 as a live view image. Then, when a release half-depression operation is performed (YES at Step C2), the control section 21 instructs the imaging section 27 to perform automatic focus adjustment (AF) and automatic exposure adjustment (AE) (Step C3). Then, the control section acquires a sensing motion signal transmitted from the motion detection device 1 (Step C4).

Next, the control section 21 analyzes the sensing motion signal (Step C5), identifies a motion pattern that is repeatedly appearing (periodic motion pattern) (Step C6), and predicts that this periodic motion pattern (repeated pattern) P1 is the next motion pattern P2 (Step C7). Subsequently, the control section 21 changes the “imaging settings” (setting of shutter speed) based on the predicted motion pattern (predicted pattern) and a delay time due to a release time lag (Step C8). That is, in a case such as that shown in FIG. 7B, the control section 21 changes the shutter speed of the “imaging settings” to be faster. In a case such as that shown in FIG. 7C, the control section 21 changes the shutter speed of the “imaging settings” to be slower.

Then, when a release full-depression operation is performed (YES at Step C9), the control section 21 acquires an image captured based on the “imaging settings” (shutter speed) and performs, on this image, image processing such as development and image compression so as to generate data in a standard file format (Step C10). Subsequently, the control section 21 records and stores it in the image memory 23c of the storage section 23 (Step C11). Then, the control section 21 judges whether the imaging mode has been cancelled (Step C12) and, when the current mode is still the imaging mode (NO at Step C12), returns to Step C1 to repeat the above-described operations. When the imaging mode is cancelled (YES at Step C12), the control section 21 exits the flow of FIG. 8 and returns to the main flow (not shown) of the entire operation of the imaging apparatus 2.

As described above, in the second embodiment, the imaging apparatus 2 acquires motion information regarding the motion of an imaging target detected by the motion detection device 1 on the imaging target side from the motion detection device 1, predicts the motion of the imaging target based on the motion information, changes the “imaging settings” based on the predicted motion of the imaging target, and controls the imaging section 27 based on the “imaging settings”. As a result of this configuration, suitable images conforming to the motion of an imaging target can be captured. Accordingly, image capturing can be performed in which the effect of the image blurring of a photographic subject is suppressed.

Also, in the imaging apparatus 2, the “imaging settings” are changed based on a predicted motion pattern and a delay time due to a release time lag. As a result of this configuration, the “imaging settings” can be changed taking into consideration a release time lag after a release operation.

(First Modification Example of Second Embodiment)

In the configuration of the second embodiment, the imaging apparatus 2 identifies a repeatedly appearing motion pattern by analyzing a sensing motion signal, and predicts the next motion of the imaging target based on the repeated pattern. However, a configuration may be adopted in which the imaging apparatus 2 acquires a movement vector by analyzing a sensing motion signal and predicts the movement of the imaging target based on the movement vector. In this configuration, the sensor section 15 may include a GPS (Global Positioning System) section (not shown) as a sensor for detecting the current position of the motion detection device 1.

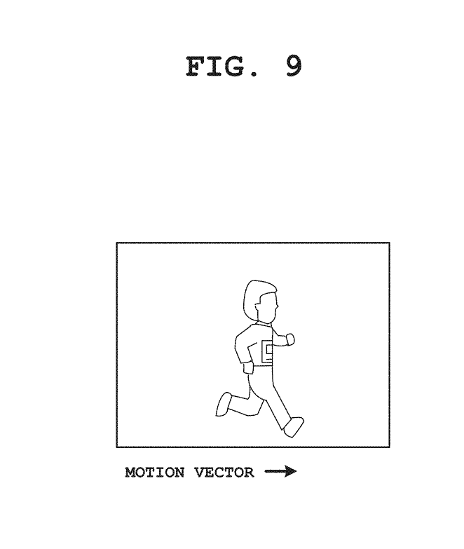

FIG. 9 is a diagram for describing a case where imaging settings are executed based on the movement direction of an imaging target.

When an imaging target is jogging, if a half-depression operation is performed on the release key, the imaging apparatus 2 receives from the motion detection device 1 a sensing motion signal that is successively fluctuating in accordance with the movement of the imaging target (jogger), and acquires the movement vector of the imaging target by analyzing the sensing motion signal. The arrow in the drawing denotes the moving vector, and the moving direction of the jogger corresponds to the arrow direction (right direction). Then, the imaging apparatus 2 changes the “imaging settings” based on this moving vector, so that the settings of ISO sensitivity, exposure, white balance and the like are executed. As a result, suitable images conforming to the movement of the imaging target can be captured.

(Second Modification Example of Second Embodiment)

In the first modification example, the imaging apparatus 2 acquires a movement vector by analyzing a sensing motion signal, and predicts the movement of the imaging target based on the motion vector. However, a configuration may be adopted in which the motion detection device 1 acquires motion vectors by analyzing a sensing motion signal. In this configuration, the imaging apparatus 2 predicts the motion of an imaging target based on motion vectors acquired by the motion detection device 1. As a result of this configuration, the applications can be simplified in the imaging apparatus 2.

### Third Embodiment

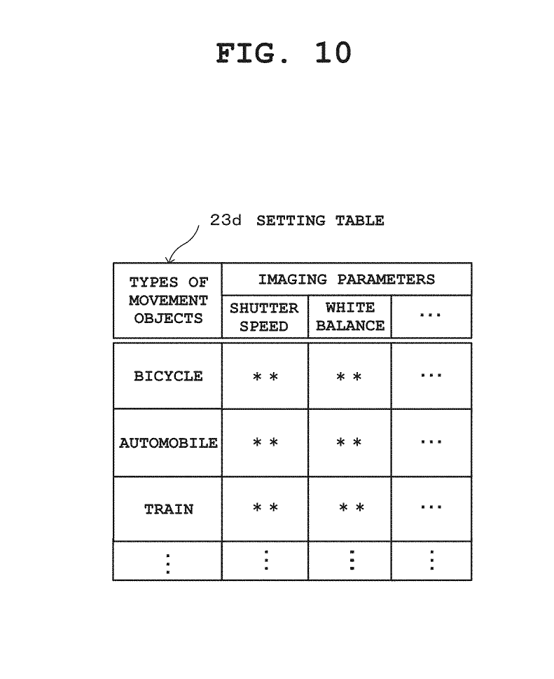

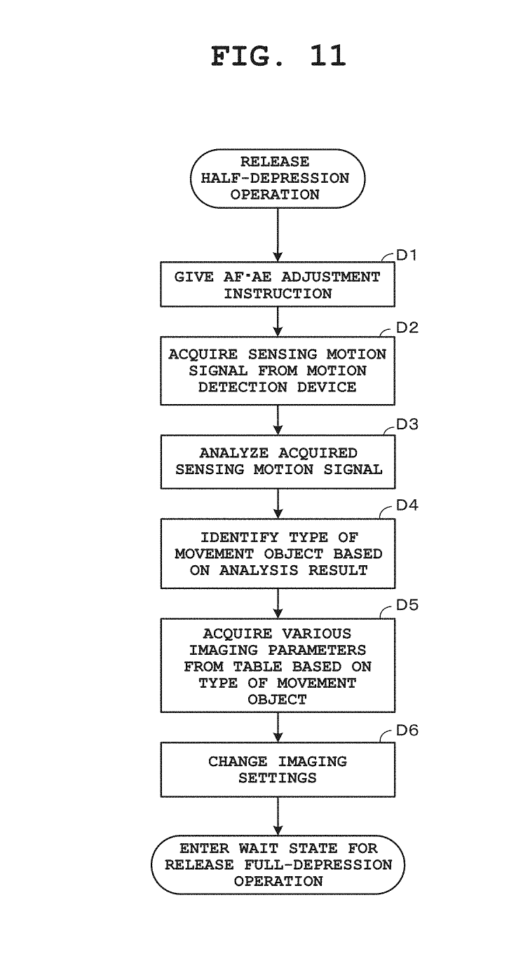

Next, a third embodiment of the present invention is described below with reference to FIG. 10 and FIG. 11.

In the configuration of the first embodiment, the imaging apparatus 2 analyzes a sensing motion signal received and acquired from the motion detection device 1, and changes the “imaging settings” in accordance with the level of the image blurring of the photographic subject based on the fluctuation status of the signal. However, in the configuration of the third embodiment, when the imaging apparatus 2 receives a sensing motion signal from the motion detection device 1 while the imaging target is using a movement object (such as a vehicle), the imaging apparatus 2 analyses the sensing motion signal and identifies the type of the movement object (such as a train or an automobile), and changes the “imaging settings” based on the type of the movement object. In this third embodiment, the sensor section 15 includes a GPS section as a sensor for detecting the current position of the motion detection device 1. Note that sections that are basically the same as those of the first embodiment or sections having the same name in both embodiments are given the same reference numerals and descriptions thereof are omitted. Hereafter, the characteristic portions of the third embodiment are mainly described.

FIG. 10 is a diagram for describing a setting table 23d to be used in the third embodiment.

This setting table 23d, which is provided in the storage section 23 of the imaging apparatus 2, has stored therein various types of “imaging parameters” which correspond to the “types of movement objects” and suitable for image capturing of the respective movement objects. In the example, the setting table 23d has stored therein “shutter speed”, “white balance”, and “camera-shake correction level” as the “imaging parameters” corresponding to the “types of movement objects” such as “bicycle”, “automobile”, and “train”. Note that the “imaging parameters” may be arbitrarily changed by a user operation in advance.

FIG. 11 is a flowchart describing a characteristic operation of the imaging apparatus 2 in the third embodiment.

First, the control section 21 of the imaging apparatus 2 performs the same processing as those of Step B1 to Step B2 in FIG. 6 (not shown). Then, when a release half-depression operation is performed, the control section 21 instructs the imaging section 27 to perform automatic focus adjustment (AF) and automatic exposure adjustment (AE) (Step D1), and acquires a sensing motion signal from the motion detection device 1 (Step D2). Subsequently, the control section 21 identifies the type of the movement object (Step D4) by analyzing the sensing motion signal (Step D3).

That is, the control section 21 comprehensively judges the movement status of the imaging target, such as the movement speed, the movement condition (shaking status), and the movement trajectory, and thereby identifies the type of the movement object. For example, based on the movement speed and the movement condition (such as low-level shaking) of the movement object the control section judges that the imaging target is using a bicycle as the movement object. Also, based on the movement speed and the movement trajectory (smooth curve) the control section judges that the imaging target is using an automobile. When the type of the movement object that is being used by the imaging target is identified as described above, the control section 21 refers to the setting table 23d based on the type of the movement object, reads out various types of imaging parameters corresponding to the type of the movement object (Step D5), and changes the “imaging settings” based on these parameters (Step D6). For example, in a case where a bicycle is being used, since the imaging target is riding the bicycle, setting for adjusting the white balance is executed to beautify the skin color. In a case where an automobile is being used, since the imaging target is driving outside and moving fast, setting for increasing the shutter speed is executed. Then, the control section 21 enters a state of waiting for a release full-depression operation in order to perform the same processing as those of Step B7 to Step B11 in FIG. 6.

As described above, in the third embodiment, the imaging apparatus 2 acquires motion information regarding the motion of an imagining target detected by the motion detection device 1 on the imaging target side, judges the type of the movement object of the imagining target based on the motion information, changes the “imaging settings” based on the type of the movement object, and controls the imaging means (imaging function) based on the “imaging settings”. As a result of this configuration, suitable images can be captured which conform to the movement of a movement object that is being used by an imaging target.

Also, the control section 21 of the imaging apparatus 2 refers to the setting table 23d based on a determined type of a movement object, reads out imaging parameters corresponding to the type of the movement object, and changes the “imaging settings”. As a result of this configuration, the setting of imaging parameters (imaging settings) suitable for a movement object can be easily executed.

In the third embodiment, the imaging apparatus 2 changes the “imaging settings” based on a determined type of a movement object. However, a configuration may be adopted in which the imaging apparatus 2 changes the “imaging settings” based on a determined type of a movement object and acquired motion information. By this configuration, more accurate settings can be achieved.

### Fourth Embodiment

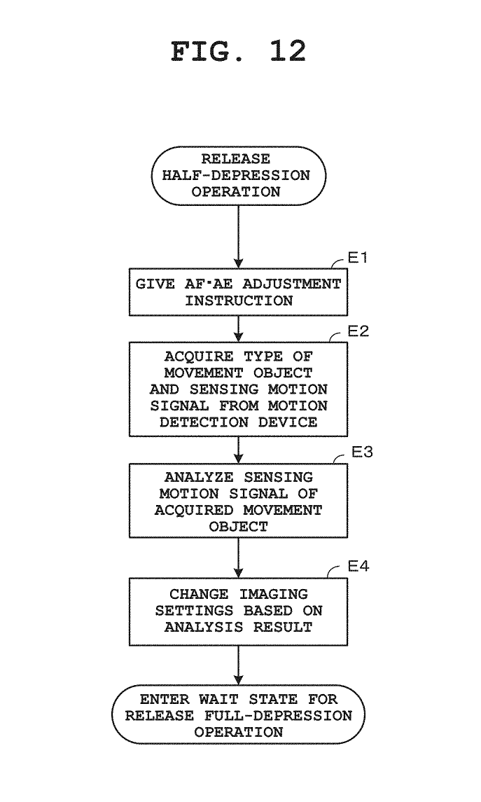

Next, a fourth embodiment of the present invention will be described below with reference to FIG. 12.

In the configuration of the third embodiment, the imaging apparatus 2 judges the type of a movement object based on a sensing motion signal acquired from the motion detection device 1 and changes the “imaging settings” based on the type of the movement object. However, in the fourth embodiment, a highly public movement object (such as a train or a bus) is taken as an imaging target, and the imaging apparatus 2 acquires a sensing motion signal and information regarding the type of the movement object from the motion detection device 1, and changes the “imaging settings” based on the type of the movement object and the sensing motion signal. Here, the motion detection device 1 is attached to a predetermined portion of a highly public movement object, and transmits identification information (movement object tag) regarding the type of the movement object together with a sensing motion signal indicating the movement of the movement object.

FIG. 12 is a flowchart showing a characteristic operation of the imaging apparatus 2 in an imaging mode in the fourth embodiment.

The control section 21 of the imaging apparatus 2 performs the same processing (not shown) as those of Step B1 to Step B2 in FIG. 6 in the imaging mode. Then, when a release half-depression operation is performed, the control section 21 instructs the imaging section 27 to perform automatic focus adjustment (AF) and automatic exposure adjustment (AE) (Step E1), acquires identification information (movement object tag) regarding the type of the movement object and a sensing motion signal of the movement object from the motion detection device 1 (Step E2), analyzes the sensing motion signal in accordance with the identification information (movement object tag) regarding the type of the movement object (Step E3), and changes the “imaging settings” based on the analysis result (Step E4).

For example, in a case where a photographer having the imaging apparatus 2 is waiting for a train that is an imaging target at a place where the train takes a curve or a train station where the train stops, the control section 21 identifies timing at which the train takes a curve or stops at the station by analyzing an acquired sensing motion signal, and optimizes the “imaging settings” in accordance with the movement of the train. Also, in a case where an autobus is an imaging target, when the bus is waiting for a traffic light or is leaving or arriving at a bus stop, the control section 21 optimizes the “imaging settings” in accordance with the movement of the autobus. Then, the control section 21 enters a state of waiting for a release full-depression operation so as to perform the same processing as those of Step B7 to Step B11 in FIG. 6.

As described above, in the fourth embodiment, the control section 21 of the imaging apparatus 2 acquires information regarding the type of a movement object serving as an imaging target detected by the motion detection device 1 on the movement object side, changes the “imaging settings” based on the acquired information regarding the type of the movement object, and controls the imaging means (imaging function) based on the “imaging settings”. As a result of this configuration, suitable images conforming to the type of a movement object that is an imaging target can be captured.

Also, the control section 21 of the imaging apparatus 2 acquires information regarding the type of a movement object serving as an imaging target detected by the motion detection device 1 on the movement object side and motion information regarding the movement of the movement object, and executes imaging settings based on the acquired information regarding the type of the movement object and the motion information regarding the movement. By this configuration, more accurate settings can be achieved.

### Fifth Embodiment

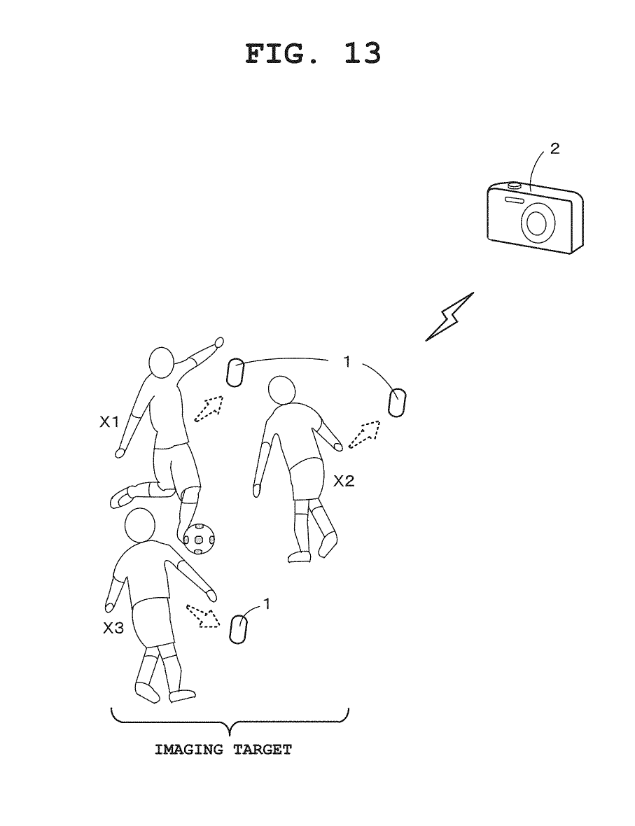

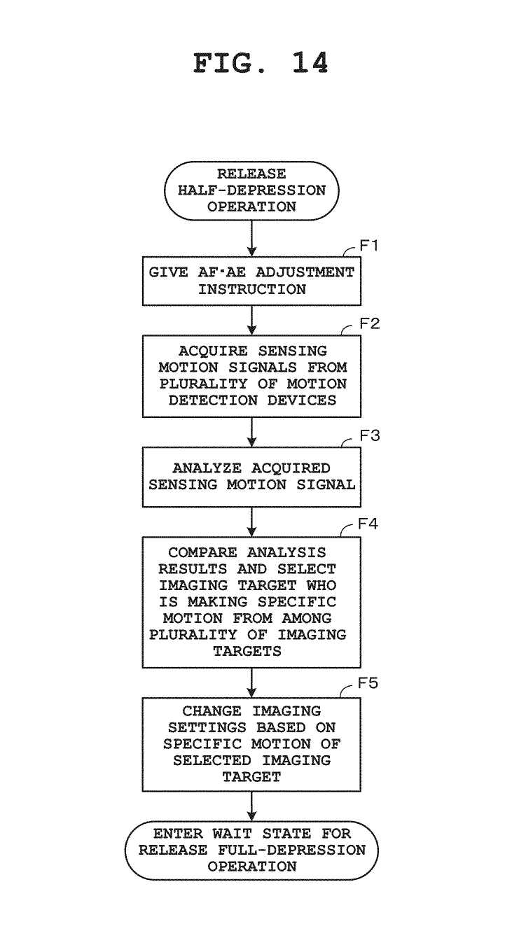

Next, a fifth embodiment of the present invention is described with reference to FIG. 13 and FIG. 14

In the configuration of the first embodiment, the imaging apparatus 2 acquires motion information by the motion detection device 1 provided on one imaging target side and executes imaging settings based on the motion information. However, in the configuration of the fifth embodiment, the imaging apparatus 2 acquires motion information by motion detection devices 1 provided on a plurality of imaging targets, compare these motion information, select one of the imaging targets based on the comparison result, and changes the “imaging settings” such that they conform to the selected imaging target.

FIG. 13 is a diagram showing, as an example where a plurality of imaging targets are photographed by the imaging apparatus 2, an example where a scene is photographed in which a plurality of soccer players (imaging targets) X1, X2 and X3 are scrambling for the soccer ball during a game. In this example, the motion detection device 1 is worn on a predetermined portion (such as the waist) of each soccer player (imaging target) X1, X2 and X3. The imaging apparatus 2 receives and compares a sensing motion signal transmitted from the motion detection device 1 of each soccer player X1, X2 and X3, selects one of the imaging targets based on the comparison result, and changes the “imaging settings” such that they conform to the selected imaging target.

FIG. 14 is a flowchart describing a characteristic operation of the imaging apparatus 2 in an imaging mode in the fifth embodiment.

The control section 21 of the imaging apparatus 2 performs the same processing (not shown) as those of Step B1 to Step B2 in FIG. 6 in the imaging mode. Then, when a release half-depression is performed, the control section 21 instructs the imaging section 27 to perform automatic focus adjustment (AF) and automatic exposure adjustment (AE) (Step F1), sequentially acquires sensing motion signals from the plurality of motion detection devices 1 (Step F2), and analyzes each sensing motion signal (Step F3).

Next, the control section 21 selects an imaging target who is making a specific motion from among the plurality of imaging targets by comparing the plurality of analysis results (Step F4), and changes the “imaging settings” such that they conform to the selected imaging target (Step F5). In the shown example, from among the plurality of soccer players X1 to X3, the soccer player X1 who is making the most strenuous movement (kicking the soccer ball) is selected, and the “imaging settings” are changed to conform to the soccer player X1. For example, the shutter speed is increased. Also, in a case where a soccer player who is jumping is selected, the “imaging settings” are changed to conform to this soccer player by, for example, the shutter speed being increased. Then, the control section enters a state of waiting for a release full-depression operation so as to perform the same processing as those of Step B7 to Step B11 in FIG. 6.

As described above, in the fifth embodiment, the imaging apparatus 2 acquires and compares motion information detected by each motion detection device 1 provided on a plurality of imaging targets and executes imaging settings based on motion information corresponding to the comparison result. As a result of this configuration, the “imaging settings” can be changed to conform to one of a plurality of imaging targets who is making a specific motion, and a suitable image conforming to the specific motion can be captured.

(First Modification Example of Fifth Embodiment)

In the configuration of the fifth embodiment, the imaging apparatus 2 compares the motion information of a plurality of imaging targets and thereby selects an imaging target who is making a specific motion. However, a configuration may be adopted in which, when an instruction is received from one of the imaging targets, the “imaging settings” are changed to conform to the motion of the imaging target. For example, a configuration may be adopted in which, when one of the plurality of imaging targets exerts strong impact on his or her own motion detection device 1 by hitting the motion detection device 1 with a hand (when signaled) and the imaging apparatus 2 detects that one of the motion detection devices 1 has been hit with a hand (detects that a signal has been given) by analyzing motion information, the imaging apparatus 2 identifies the imaging target that has hit the motion detection device changes the “imaging settings” such that they conform to the motion of the imaging target. By this configuration, imaging settings can be executed as intended by an imaging target.

In the above-described embodiments, a configuration may be adopted in which imaging timing is controlled based on the “imaging settings”. That is, a configuration may be adopted in which, when a specific motion (such as posing) of an imaging target is detected by motion information being analyzed, automatic image capturing is performed by the shutter being automatically controlled. By this configuration, automatic image capturing can be performed as intended by an imaging target.

Also, in the above-described embodiments, the imaging apparatus according to the present invention has been applied to a camera. However, the imaging apparatus may be applied to a personal computer having a camera function, a PDA (Personal Digital Assistant), a table terminal device, a portable telephone such as a smartphone, an electronic game machine, a music player and the like.

Moreover, the “apparatus”, the “device” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An imaging apparatus comprising:
an imaging section;
an acquisition section which acquires motion information regarding a motion of an imaging target detected by a motion detection device located on the imaging target side, from the motion detection device;
a prediction section which predicts a motion of the imaging target based on the motion information acquired by the acquisition section;
a setting section which executes imaging settings based on the motion of the imaging target predicted by the prediction section; and
a control section which controls the imaging section based on contents of the imaging settings executed by the setting section.

2. The imaging apparatus according to claim 1, wherein the setting section executes the imaging settings based on the motion of the imaging target predicted by the prediction section and a delay time due to a release time lag.

3. The imaging apparatus according to claim 1, further comprising:
an analysis section which acquires a motion vector by analyzing the motion information acquired by the acquisition section,
wherein the prediction section predicts the motion of the imaging target based on the motion vector acquired by analysis by the analysis section.

4. The imaging apparatus according to claim 2, further comprising:
an analysis section which acquires a motion vector by analyzing the motion information acquired by the acquisition section,
wherein the prediction section predicts the motion of the imaging target based on the motion vector acquired by analysis by the analysis section.

5. The imaging apparatus according to claim 1, wherein the acquisition section acquires, from the motion detection device, a motion vector acquired by analysis of the motion information detected by the motion detection device, and
wherein the prediction section predicts the motion of the imaging target based on the motion vector acquired by the acquisition section.

6. The imaging apparatus according to claim 2, wherein the acquisition section acquires, from the motion detection device, a motion vector acquired by analysis of the motion information detected by the motion detection device, and
wherein the prediction section predicts the motion of the imaging target based on the motion vector acquired by the acquisition section.

7. An imaging apparatus comprising:
an imaging section;
an acquisition section which acquires motion information regarding a motion of an imaging target detected by a motion detection device located on the imaging target side, from the motion detection device;
a judgment section which judges a type of a movement object that is the imaging target by analyzing the motion information acquired by the acquisition section;
a setting section which executes imaging settings based on the type of the movement object judged by the judgment section; and
a control section which controls the imaging section based on contents of the imaging settings executed by the setting section.

8. The imaging apparatus according to claim 7, wherein the setting section executes the imaging settings based on the type of the movement object judged by the judgment section and the motion information acquired by the acquisition section.

9. The imaging apparatus according to claim 8, further comprising:
a storage section which stores imaging parameters provided for each movement object type, in association with a corresponding movement object type,
wherein the setting section refers to the storage section based on the type of the movement object, reads out imaging parameters stored in association with the type of the movement object, and executes the imaging settings.

10. An imaging apparatus comprising:
an imaging section;
an acquisition section which acquires information which is regarding a type of a movement object serving as an imaging target and has been detected by a motion detection device located on the movement object side, from the motion detection device;
a setting section which executes imaging settings based on the information regarding the type of the movement object acquired by the acquisition section; and
a control section which controls the imaging section based on contents of the imaging settings executed by the setting section.

11. The imaging apparatus according to claim 10, wherein the acquisition section acquires the information regarding the type of the movement object detected by the motion detection device and motion information regarding a movement of the movement object, and
wherein the setting section executes the imaging settings based on the information regarding the type of the movement object and the motion information regarding the movement of the movement object acquired by the acquisition section.

12. An imaging method for an imaging apparatus, comprising:
a step of acquiring motion information regarding a motion of an imaging target detected by a motion detection device located on the imaging target side, from the motion detection device;
a step of predicting a motion of the imaging target based on the acquired motion information;
a step of executing imaging settings based on the predicted motion of the imaging target; and
a step of controlling an imaging section based on contents of the executed imaging settings.

13. A non-transitory computer-readable storage medium having a program stored thereon that is executable by a computer in an imaging apparatus to actualize functions comprising:
processing for acquiring motion information regarding a motion of an imaging target detected by a motion detection device located on the imaging target side, from the motion detection device;
processing for predicting a motion of the imaging target based on the acquired motion information;
processing for executing imaging settings based on the predicted motion of the imaging target; and
processing for controlling an imaging section based on contents of the executed imaging settings.

14. An imaging method for an imaging apparatus, comprising:
a step of acquiring motion information regarding a motion of an imaging target detected by a motion detection device located on the imaging target side, from the motion detection device;
a step of judging a type of a movement object that is the imaging target by analyzing the acquired motion information;
a step of executing imaging settings based on the judged type of the movement object; and
a step of controlling an imaging section based on contents of the executed imaging settings.

15. A non-transitory computer-readable storage medium having a program stored thereon that is executable by a computer in an imaging apparatus to actualize functions comprising:
processing for acquiring motion information regarding a motion of an imaging target detected by a motion detection device located on the imaging target side, from the motion detection device;
processing for judging a type of a movement object that is the imaging target by analyzing the acquired motion information;
processing for executing imaging settings based on the judged type of the movement object; and
processing for controlling an imaging section based on contents of the executed imaging settings.

16. An imaging method for an imaging apparatus, comprising:
a step of acquiring information which is regarding a type of a movement object serving as an imaging target and has been detected by a motion detection device located on the movement object side, from the motion detection device;
a step of executing imaging settings based on the acquired information regarding the type of the movement object; and
a step of controlling an imaging section based on contents of the executed imaging settings.

17. An imaging method for an imaging apparatus, comprising:
a step of acquiring pieces of motion information regarding motions of a plurality of imaging targets detected by a plurality of motion detection devices respectively located on each imaging target side, from the plurality of motion detection devices;
a step of comparing the acquired pieces of motion information of the plurality of imaging targets, and executing imaging settings based on a piece of motion information selected in accordance with a comparison result; and
a step of controlling an imaging section based on the executed imaging settings.
